(19) United States
(12) Patent Application Publication
(10) Pub. No.: US 2002/0010626 A1
(43) Pub. Date: Jan. 24, 2002

(54) Internert advertising and information delivery system

(76) Inventor: Eyal Agmoni, Tokyo (JP)

Correspondence Address: Pandiscio & Pandiscio, 470 Totten Pond Road, Waltham, MA, 02451-1914, US

(21) Appl. No.: 09/850,977

(22) Filed: May 8, 2001

Related U.S. Application Data
(60) Provisional application No. 60/206,169, filed on May 22, 2000.

(51) Int. Cl. G06F 17/60

(52) U.S. Cl. 705/14

(57) ABSTRACT

A novel Internet advertising and information delivery system is disclosed comprising a novel cursor, wherein the cursor comprises two components: the traditional pointer component, and a small window component adjacent to the pointer component of the cursor. Advertising and/or other information is displayed in the window component. The user's attention is constantly directed to this displayed advertisement and/or other information since it is part of the cursor. Another form of the novel Internet advertising and information delivery and information delivery system takes advantage of the fact that most users access the Internet by telephone, using a local dial-up access number. Through the use of Caller ID, lease line codes or other fixed circuit identification, the ISP may identify the likely physical location of the user. Localized advertising and/or other information can then be closely targeted to the user. This targeted localized advertising and/or other information can be delivered to the user through conventional banner advertising or, more preferably, through the novel cursor described above. Yet another form of the novel Internet advertising and delivery system provides more personalized advertising by using additional identifying information, such as user name and ID. This additional information allows the system to retrieve the user's profile and provide customized advertising based upon this profile. For example, after keying in a password, the system not only recognizes the location of the user in the Boston area, but it also recognizes that the user is a female, in the 20 to 30 year old group, and has an interest in flower arranging. As such, information provided by the user during registration such as sex, age, and interests, may later be used to target advertising.

### REFERENCE TO PENDING PRIOR PATENT APPLICATION

This patent application claims benefit of pending prior U.S. Provisional Patent Application Serial No. 60/206,169, filed May 22, 2000 by Eyal Agmoni for INTERNET ADVERTISING SYSTEM, which patent application is hereby incorporated herein by reference.

### FIELD OF THE INVENTION

This invention relates to computer systems in general, and more particularly to Internet systems. Even more particularly, this invention relates to apparatus and methods for advertising and delivering information over the Internet.

### BACKGROUND OF THE INVENTION

Advertising on the Internet has become one of the most important sources of revenue for Web portals and for E-commerce sites, regardless of whether those E-commerce sites are business-to-consumer (“B2C”) or business-to-business (“B2B”).

Such advertising generally involves presenting a so-called banner advertisement to the user. These banner advertisements are effectively a sort of “billboard” for displaying advertising and information to the user, with the banner occupying a preset position on a given Web page. See, for example, FIG. 1, which shows a Web page 5 having a banner advertisement 10. The advertisement presented on the banner can be “static”, in the sense that it comprises a fixed image (e.g., fixed text or a fixed picture), or the advertisement can be “dynamic”, in the sense that it comprises a changing image (e.g., streaming text or streaming video). Furthermore, in some systems, each advertisement is presented on the banner for a predetermined period of time, whereupon it is replaced by a subsequent advertisement. More often, however, the advertisement presented on the banner is not replaced with a new advertisement until the user refreshes the Web page.

Popular sites such as Yahoo.com (a Web portal) and Priceline.com (an E-commerce site) have been able to charge substantial amounts of money for banner advertisements, since large numbers of users visit their sites.

However, the effectiveness of banner advertising is now being questioned.

For one thing, research has shown that the average “surfing” time spent on a particular Web page is only about eight seconds. Thus, at best, a given banner advertisement is typically presented to the user for only a brief interval. Furthermore, since the banner occupies a preset position on the Web page, many users simply ignore the banner advertisement altogether and look directly at the content of the Web page. This is particularly true with respect to repeat users, who already have some familiarity with the Web page layout. Additionally, even if the user initially views the banner advertisement, the user typically scrolls away from the banner as the user reviews the contents of the Web page. Furthermore, since most banner advertisements are not replaced with a new banner advertisement until the Web page is refreshed, prior art banner advertising can typically deliver only a limited number of advertisements to a given user until the user refreshes the Web page.

In addition to the foregoing, since banner advertising is carried by the actual Web pages themselves, the revenue from banner advertising is effectively monopolized by the owners of those sites, e.g., by the owners of Web portals and E-commerce sites. Thus, banner advertising is effectively useless as a source of revenue for Internet service providers (“ISP's”), unless the ISP owns the particular Web portal site and the user accesses that site. However, ISP's currently need a medium for generating advertising revenue, since ISP's are faced with the large expenses associated with networking and promotion. In addition, ISP's offer the significant advantage that the average Internet surfing session is approximately 40 minutes in length, which is substantially longer than the average Web page viewing session of eight seconds referred to above.

Another problem associated with current Internet advertising relates to the degree to which the advertising itself can be targeted. More particularly, when banner advertisements are displayed on a highly specialized Web site (e.g., a Web site directed to Corvette automobile enthusiasts), those banner advertisements will naturally have a high degree of targeting to a particular audience. However, when banner advertisements are displayed on a broad application Web site (e.g., a Web portal), those banner advertisements will typically have a low degree of targeting to a particular audience. It is widely recognized that highly targeted advertising is more effective than, and hence more valuable than, weakly targeted advertising.

In addition to the foregoing, targeted information may also be delivered via E-mail to a particular audience. This targeted information may either be solicited or non-solicited.

### SUMMARY OF THE INVENTION

As a result, one object of the present invention is to provide a novel Internet advertising and information delivery system which utilizes a superior system to direct advertisements and/or other information to the eyes of the user, whereby to significantly increase the effectiveness of those advertisements and/or other information.

Another object of the present invention is to provide a novel Internet advertising and information delivery system which can be used by content providers, including ISP's, ASP's, Web hosting companies and others, to generate advertising revenue and/or other types of revenue.

And another object of the present invention is to provide a novel Internet advertising and information delivery system which permits advertisements and/or other information to be more closely targeted to a particular audience and to address the exact specifications of advertisers and information delivery companies including, for example, user location, time, personalized user profiles such as gender, age, and interests, etc.

These and other objects are addressed by the present invention, which comprises a novel Internet advertising and information delivery system.

In one form of the invention, the novel Internet advertising and information delivery system comprises a novel cursor, wherein the cursor comprises two components: the traditional pointer component for pointing to a particular location on the computer screen in response to the movement of a mouse, track ball, touchpad, etc., and a small window component which is adjacent to the pointer component and which moves about the screen in conjunction with the pointer component. In essence, the two cursor components (i.e., pointer and window) move about the screen as a single cursor unit. Advertising and/or other information (including but not limited to alerts, stock quotes, instant messages, news, hobbies, etc.), in static and/or dynamic form, are displayed in the cursor's window component regardless of the cursor's position on the screen and regardless of the Web page being displayed. The foregoing arrangement is highly advantageous, since the user is typically looking at the cursor constantly during a session and hence the user's attention is constantly being directed to the advertisement and/or other information displayed by the cursor.

Furthermore, since the advertising and/or other information displayed by the cursor is not necessarily generated by that particular Web page, the advertising and/or other information can be provided by, and the advertising and/or other revenue captured by, the ISP. As such, the advertising and/or other information is not “built in” to a page but can be linked to the page. For example, if a user is looking at a Pepsi Web page, a Coke advertisement may be displayed. This is an example of what is meant by a linked advertisement.

In another form of the invention, the novel Internet advertising and information delivery system takes advantage of the fact that most users access the Internet by a telecommunications conduit in which the user's current location can be determined. This includes, for example, telephone access using a local dial-up access number. Through the use of Caller ID, the ISP can identify the particular local dial-up access number used by the user and hence the likely physical location of that user. However, the invention is not limited to dial-up technologies but also includes other access methods and location identification systems, e.g., leased line systems, DSL systems, cable systems, etc. Once the likely physical location of the user has been determined, localized advertising and/or other information delivery can be closely targeted to that user. This targeted localized advertising and/or other information can be delivered to the user through the use of conventional banner advertising or, more preferably, through the use of the novel cursor described above.

In a preferred embodiment of the invention, the novel Internet advertising and information delivery system looks not only at the dial-up access number but also at other identifying information. For example, such identifying information includes other types of telephone access information (e.g., DSL access, T1 lines, etc.), user name, a PIN, and other submitted or deduced identifiers. Using this other identifying information, a user's home address, as well as any basic profile previously gathered about that user, is available when the Internet advertising and information delivery system is accessed by the user on another computer or at a remote location.

In another form of the novel Internet advertising and delivery system more personalized advertising is provided by using additional identifying information, such as user name and ID. This additional information allows the system to retrieve the user's profile and provide customized advertising based upon this profile. For example, after keying in a password, the system not only recognizes the location of the user in the Boston area, but it also recognizes that the user is a female, in the 20 to 30 year old group, and has an interest in flower arranging. As such, information provided by the user during registration such as sex, age, and interests, may later be used to target advertising.

Additionally, an incentive system may be provided, e.g., where the Internet advertising and information delivery system can be disabled by the user at will and where the user is rewarded according to the length of time that the system is not disabled by the user. In essence, with this system, the user earns a commission from the ISP for viewing the advertisements and/or other information. This commission may include such rewards as points, money, services, “hot” deals, additional information, alerts, E-money, etc. Each ISP may decide what type of reward is given to users, and at what rate that award is given to users.

### BRIEF DESCRIPTION OF THE DRAWINGS

These and other objects and features of the present invention will be more fully disclosed or rendered obvious by the following detailed description of the invention, which is to be considered together with the associated drawings wherein like numbers refer to like parts and further wherein:

FIG. 1 is an illustration of a conventional Web page;

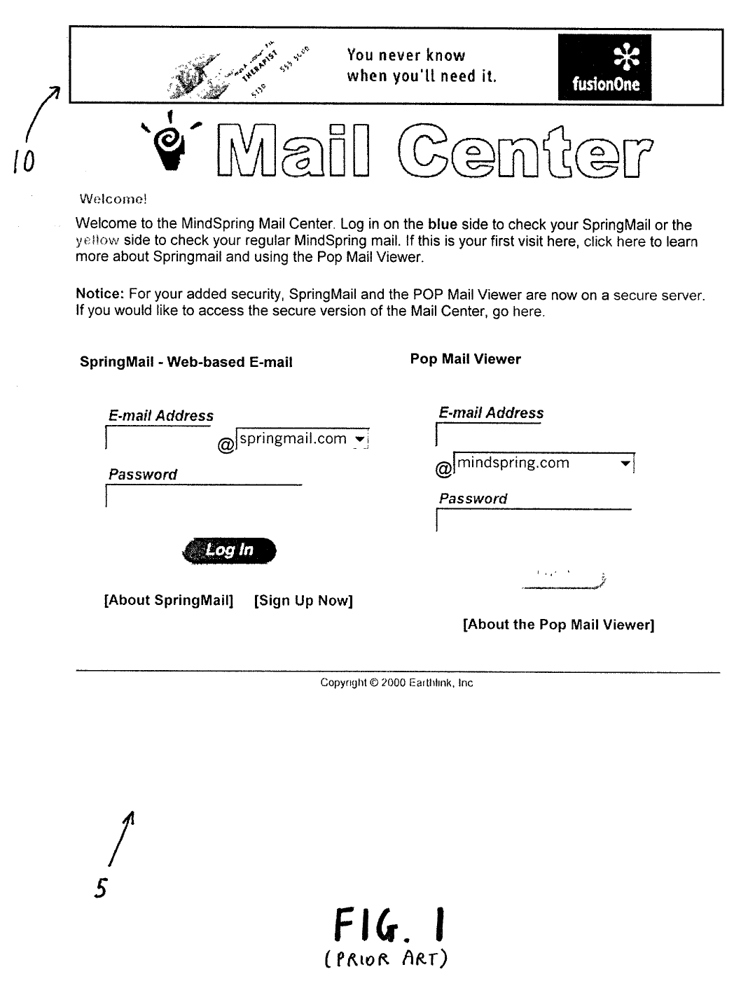

FIG. 2 is an illustration of a screen display generated with a conventional Internet system;

FIG. 3 is an illustration of a screen display generated with the present invention;

FIG. 4 is an illustration of an alternative screen display generated with the present invention;

FIG. 4A is a simple flowchart illustrating one manner of practicing the present invention; and

FIG. 5 is a schematic illustration of a novel Internet system formed in accordance with the present invention.

### DETAILED DESCRIPTION OF THE INVENTION

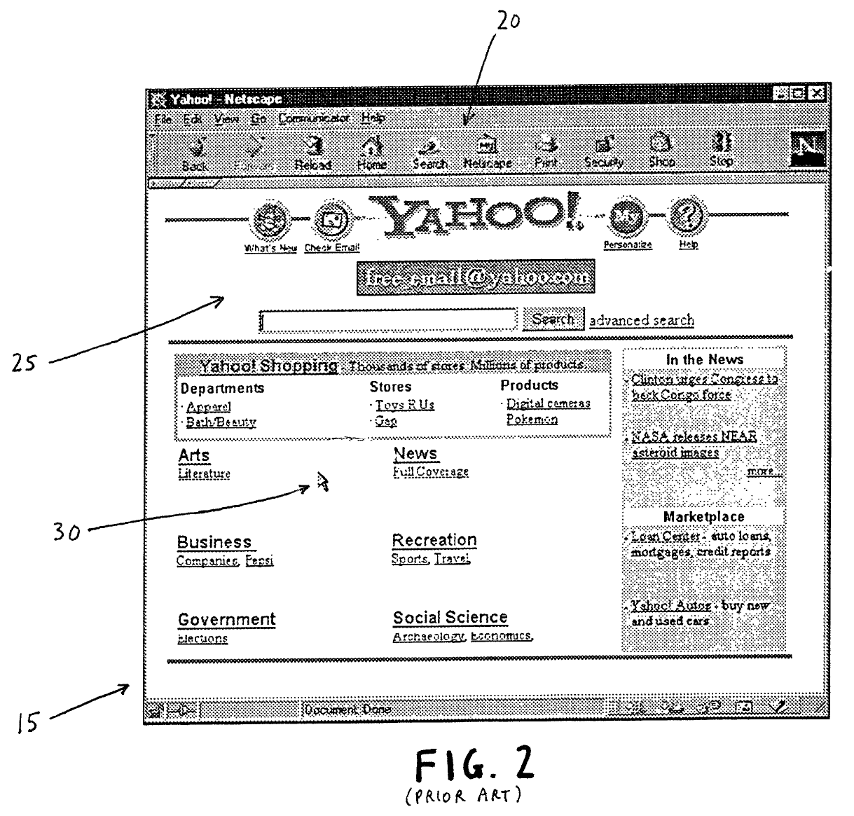

Looking now at FIG. 2, there is shown a typical prior art screen display 15. Screen display 15 generally comprises the Internet browser software 20, the contents of a particular Web page 25, and a cursor 30. In this prior art screen display, cursor 30 typically comprises a pointer element for pointing to a particular location on the computer screen in response to the movement of a mouse, track ball, touchpad, etc.

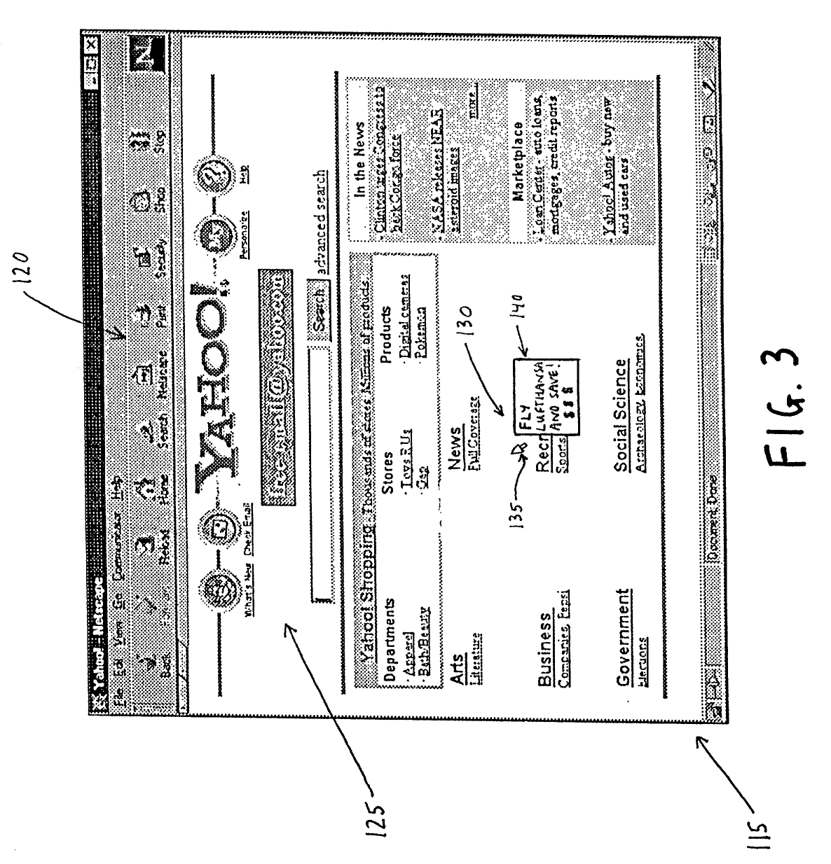

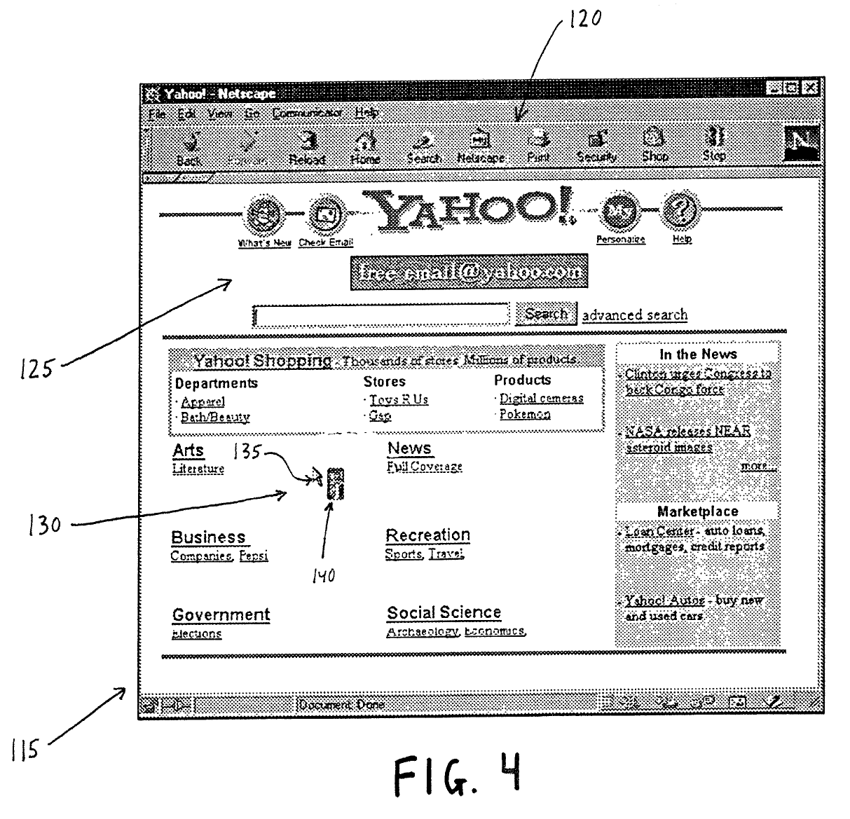

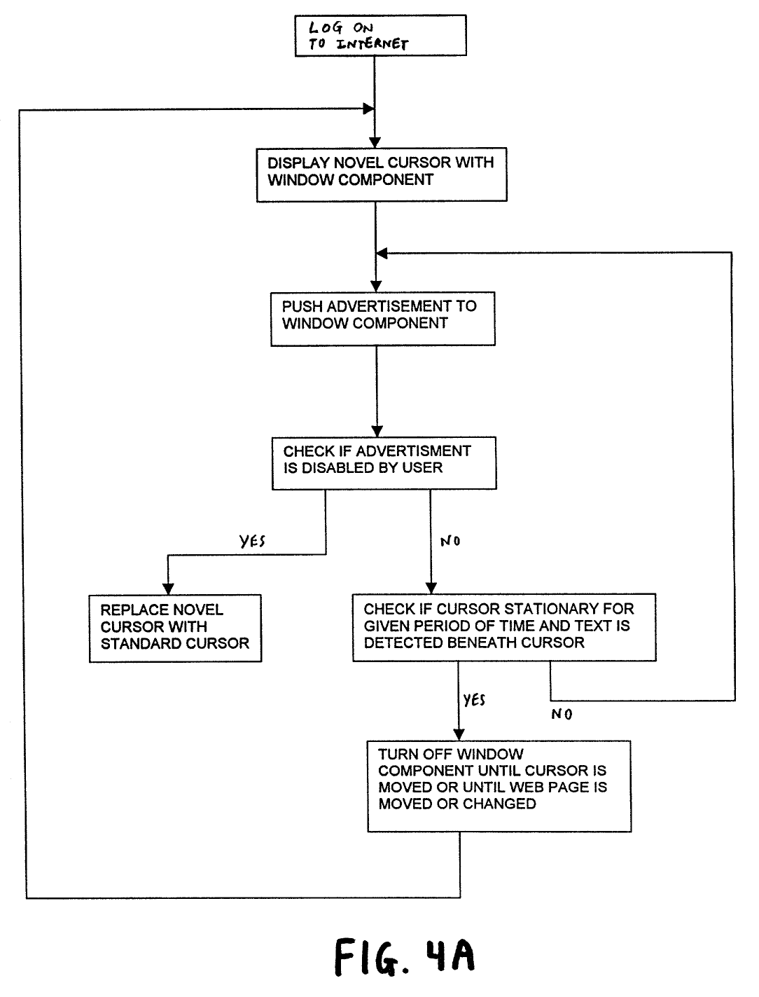

Looking next at FIGS. 3 and 4, there is shown a new screen display 115 generated in accordance with the present invention. Screen display 115 comprises the Internet browser software 120, the contents of a particular Web page 125, and a novel cursor 130. Novel cursor 130 serves to both (i) point to a particular location on the computer screen in response to the movement of a mouse, track ball, touchpad, etc., and (ii) display advertisements and/or other information to the user. To this end, novel cursor 130 comprises a pointer component 135 for pointing to a particular location on the computer screen, and a window component 140 for displaying advertisements to the user. Window component 140 is adjacent to pointer component 135 and moves about the screen in conjunction with pointer component 135. In essence, the two cursor components (i.e., pointer component 135 and window component 140) move about the screen as a single cursor unit. The system may be configured so that if cursor 130 is stationary for a given period of time and text is detected under cursor 130, window component 140 may automatically turn off so as to allow the user to read the text beneath the window component 140. Alternatively, window component 140 may be rendered semi-transparent so as to permit the underlying text to be read by the user. Window component 140 may include a viewable border (see, for example, FIG. 3) or it may appear borderless (see, for example, FIG. 4), in which case the extent of the window component will only be apparent from its viewable content and/or from the footprint it presents on the underlying Web page. In this respect it should be appreciated that window component 140 may have a background color and/or pattern as desired.

Advertising and/or other information is displayed to the user in window component 140 regardless of the position of the cursor on the screen. This advertising and/or other information can be static, in the sense that it comprises a fixed image (e.g., fixed text or a fixed picture), or the advertising and/or other information can be dynamic in the sense that it comprises a changing image (e.g., streaming text or streaming video). Furthermore, a given advertisement and/or piece of information may be presented on the window component 140 for a predetermined period of time, whereupon it may be replaced by a subsequent advertisement and/or piece of information. This may be done independently of any change, or lack of change, in the underlying Web page.

FIG. 4A is a simple flowchart illustrating one manner of practicing the present invention. For convenience, the flowchart shown in FIG. 4A is described in the context of delivering advertisements to the user. However, it should also be appreciated that the system is also capable of delivering other types of information to the user, e.g., alerts, stock quotes, instant messages, news, hobbies, etc.

If desired, the system can be configured so that the cursor's window component 140 can be disabled at will by the user, and where the user is rewarded according to the length of time that the system is not disabled by the user. This reward may be in the form of points, money, services, “hot” deals, additional information, alerts, E-money, etc. Each ISP may decide what type of reward is given to users, and at what rate it is given.

If desired, items in addition to, or in place of, advertisements can be displayed on window component 140. By way of example but not limitation, an E-mail icon can be displayed in window component 140 to indicate to the user that E-mail has been received. Alerts, stock quotes, instant messages, news, hobbies, etc. can also be displayed in window component 140.

The foregoing construction is highly advantageous, since the user is typically looking at the cursor constantly during a session and hence the user's attention is constantly being directed to the advertisement and/or other information displayed by the cursor, whereby to increase the effectiveness of the advertising and/or other information.

Furthermore, unlike banner advertising, where the advertising is linked to a particular Web page (and, in fact, to a particular location on that Web page), cursor advertising and information delivery is independent of the Web page being displayed at a given time. As a result, advertising and/or other information can be provided by, and the advertising revenue and/or other revenue captured by, the ISP.

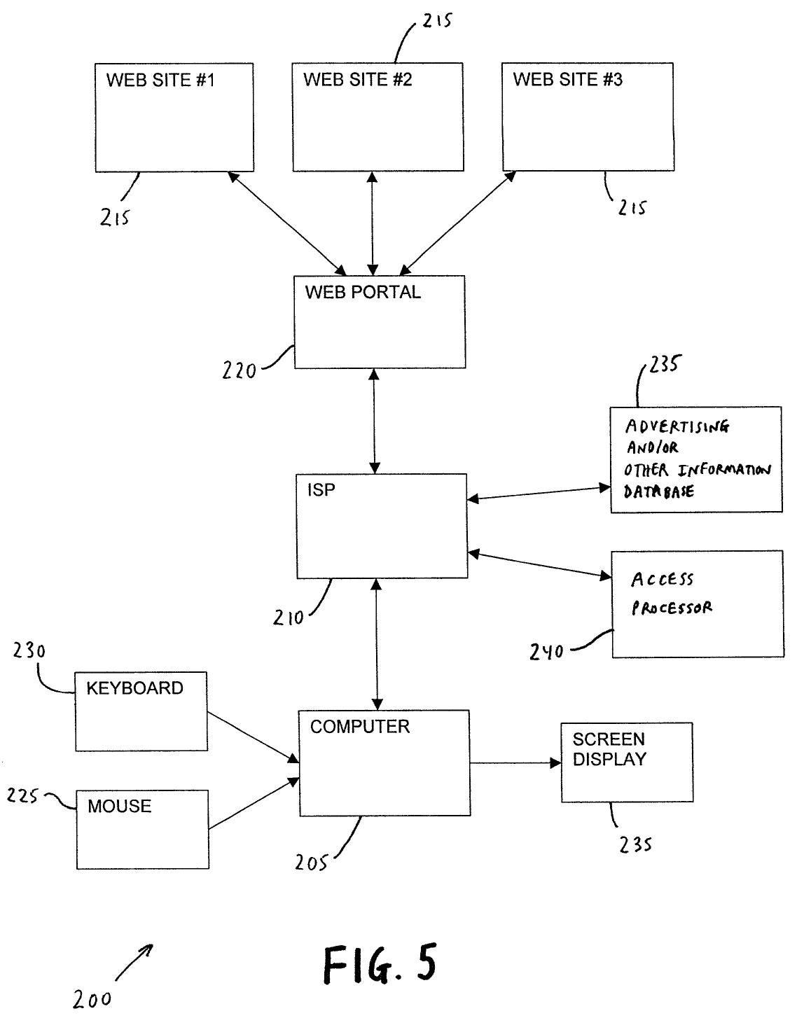

More particularly, and looking now at FIG. 5, there is shown a novel Internet system 200 formed in accordance with the present invention. Internet system 200 includes the “traditional” Internet architecture where a user's computer 205 uses an ISP 210 to access various Web sites 215, frequently initiating the Internet session through a Web portal 220. The user typically uses a mouse 225 (or track ball, touchpad, etc.) and a keyboard 230 to navigate about the Web, with the current Web page being displayed on the screen display 235.

In accordance with the present invention, when the user signs up with ISP 210, the user's computer 205 is provided with appropriate software to reconfigure the form of its cursor, whereby the cursor will appear in the form of the cursor 130 shown in FIGS. 3 and 4. Additionally, ISP 210 is configured to access an advertising and/or other information database 235 which holds the advertisements and/or other information which are pushed to window component 140 of cursor 130.

During an Internet session, ISP 210 permits computer 205 to access the Web in the traditional manner. This includes the delivery of Web pages to the computer for display to the user. In this respect it should be appreciated that these Web pages may include the traditional form of banner advertising discussed above. In addition, however, and in accordance with the present invention, ISP 210 will push advertisements and/or other information from advertising and/or other information database 235 to window component 140 of cursor 130, whereby those advertisements and/or other information will be displayed to the user.

In another preferred form of the invention, Internet system 200 includes an access processor 240 to determiner the user's access location. By way of example, access processor 240 may comprise a Caller ID processor. The Caller ID processor is intended to take advantage of the fact that most users access the Internet by telephone, using a local dial-up access number. Through the Caller ID processor, the ISP can identify the particular local dial-up access number used by the user and hence the likely physical location of the user. Once the likely physical location of the user is known, ISP 210 can closely target localized advertising and/or other information to the user. Alternatively, other identifying information (e.g., other types of telephone access information, user name, PIN, personalized user profiles including gender, age, and interests, etc.) can be used to closely target advertising and/or other information to the user. In addition, Internet system 200 provides more personalized advertising by using additional identifying information, such as user name and ID. This additional information allows Internet system 200 to retrieve the user's profile and provide customized advertising based upon this profile. For example, after keying in a password, the system not only recognizes the location of the user in the Boston area, but it also recognizes that the user is a female, in the 20 to 30 year old group, and has an interest in flower arranging. As such, information provided by the user during registration such as sex, age, and interests, may later be used to target advertising. This targeted advertising can be delivered to the user through the use of the novel cursor 130 described above or, alternatively, through the use of conventional banner advertising of the sort described above.

An example of the operation of Internet system 200 will now be provided.

Suppose sales for PizzaHouse products are slow in the Boston area but satisfactory throughout the rest of the United States. A strategic decision is made to increase advertising in the Boston area in order to improve sales in that area. Part of the advertising will be done on the Internet but, since sales are slow only in the Boston area, there is no need to direct this Internet advertising to the remainder of the country.

The person in charge of promotion for PizzaHouse would contact the ISP's and specify the advertising details. These advertising details might include the following:

Slogan: “Order PizzaHouse now and get one for free”.

Area of promotion: customers located in or near Boston.

Time: advertising to occur between 5:00 p.m. and 11:00 p.m. for the next 7 consecutive days.

Repetition: once every 5 minutes.

Extra information: if the customer is accessing a competitor's Web page, launch an immediate “counterattack” promotion.

Mouse: enable mouse “right click” to order online from any Web page. Alternatively, an ordering icon is placed on the task bar to allow the user to click to order online from any Web page. After the ordering icon is selected, several past advertisements may be shown such that the user can scroll down and select the desired advertisement.

Thereafter, Mr. A is living in Boston and decides to access the Web at 3:45 p.m. He has been surfing ever since. At 5:00 p.m. he will start to receive the PizzaHouse ads on his cursor every 5 minutes. If the advertising is successful and Mr. A decides to order a pizza, Mr. A can call his local PizzaHouse outlet to order a pizza, or click the right button on his mouse or click the ordering icon on his task bar to go directly to the PizzaHouse Web page to order online. However, if Mr. A were to call his friend Mr. B in New York to tell him about this ad campaign, Mr. A would find that this ad campaign has not been promoted in New York, since this ad campaign is geographically limited to just the Boston area.

Mr. A can eliminate the advertising on his cursor by clicking a “right click” and then scrolling down to the last option that says: “surfing free of ads”. Basically, this selection will send a signal to the ISP advising the ISP that this user does not wish to receive any advertisements. However, the longer that the user does not disable the advertising, the more that the user will be rewarded with points, money, services, etc. in return for viewing the advertising.

If Mr. A decides to log onto the Web page for Dom's Pizza to see if there is a better offer at Dom's Pizza, then immediately, without waiting for the 5 minutes intervals, the ISP will start to promote—constantly—PizzaHouse on the cursor until the user either leaves the Dom's Pizza page or clicks on the right mouse button to call up the option of terminating cursor advertising.

The user has an incentive to keep the cursor advertising feature “on”, i.e., to receive rewards for the length of time that the advertising feature is enabled. In addition, the user has an incentive to keep the advertising feature “on” in order to keep receiving “hot” offers on the spot, and also to be notified if the user receives any new e-mail while the user is looking at different Web pages.

For example, incentives rewarded to the user may include “hot” deals on advertised products, additional information or alerts of interest, bonus points, E-money etc.

The system also allows targeted advertising in other ways. In the aforementioned PizzaHouse example, the user is surfing to buy a specific product on the Web and the ISP “knows” (from the Web address) what the user is accessing. This allows the ISP to approach the user with advertising related to the user's specific interests.

As a result, with this system, the ISP can generate advertising revenue and/or other information delivery revenue regardless of what page the user is viewing, and regardless of how long the user stays with that page.

If desired, advertisements and/or other information delivery can be continued after the user logs off the Web, by inserting extra “cookies” in the user's computer, along with some advertisements, and the advertising will be “played” on the user's cursor “billboard” even after the user logs off the Web.

Numerous advantages are obtained through the use of the present invention.

For one thing, the present invention provides a novel Internet advertising and information delivery system which utilizes a superior system to direct advertisements and/or other information to the eyes of the user, whereby to significantly increase the effectiveness of those advertisements and/or other information.

And the present invention provides a novel Internet advertising and information delivery system which can be used by ISP's to generate advertising revenue.

And the present invention provides a novel Internet advertising and information delivery system which permits advertisements and/or other information to be more closely targeted to a particular audience. This feature benefits the advertisers and information delivery companies as well as the user, since the advertisements and/or other information will be more suitable to the user's interests.

In another preferred embodiment of the present invention, alerts relating to specific subjects may be provided as a service to the user and, in addition, alerts may be sponsored by an entity having a relationship to the ISP providing the alerts. One example is a sports alert, which may be sponsored by a sports network.

Another preferred embodiment of the invention provides instant messaging, such as the AOL “Instant Messenger” product, on the cursor alert.

Still another preferred embodiment of the invention allows customization of the alerts as desired by the user.

It should, of course, be appreciated that the present invention is by no means limited to the particular constructions and method steps disclosed above and/or shown in the drawings, but also comprises any modifications or equivalents within the scope of the claims.

What is claimed is:

1. An Internet advertising and information delivery system comprising:
a cursor comprising:
a pointer component for pointing to a particular location on the computer screen in response to the movement of a mouse, track ball, touchpad, etc.; and
a window component adjacent to the pointer component and which moves about the screen in conjunction with the pointer component, such that the two cursor components move about the screen as a single cursor unit, with advertising and/or other information being displayed in the cursor's window component regardless of the cursor's position on the screen.

2. The Internet advertising and information delivery system of claim 1 wherein the window component includes a viewable border.

3. The Internet advertising and information delivery system of claim 1 wherein the window component appears borderless.

4. The Internet advertising and information delivery system of claim 1 wherein the window component includes a background color.

5. The Internet advertising and information delivery system of claim 1 wherein the window component includes a background pattern.

6. The Internet advertising and information delivery system of claim 1 wherein the advertising and/or other information displayed is static.

7. The Internet advertising and information delivery system of claim 6 wherein the static advertising includes fixed text.

8. The Internet advertising and information delivery system of claim 6 wherein the static advertising includes a fixed picture.

9. The Internet advertising and information delivery system of claim 1 wherein the advertising and/or other information being displayed is dynamic.

10. The Internet advertising and information delivery system of claim 9 wherein the dynamic advertising and/or other information includes streaming text.

11. The Internet advertising and information delivery system of claim 9 wherein the dynamic advertising and/or other information includes streaming video.

12. The Internet advertising and information delivery system of claim 1 wherein the window component includes at least one icon.

13. The Internet advertising and information delivery system of claim 12 wherein the at least one icon is activated by clicking a mouse button.

14. The Internet advertising and information delivery system of claim 12 wherein the at least one icon further includes an E-mail icon for indicating that E-mail has been received.

15. The Internet advertising and information delivery system of claim 14 wherein the E-mail is displayed by clicking a mouse button.

16. The Internet advertising and information delivery system of claim 1 wherein said window component can be disabled at will by a user.

17. The Internet advertising and information delivery system of claim 16 wherein the system is adapted to reward a user according to the length of time that the window component is not disabled by a user.

18. The Internet advertising and information delivery system of claim 16 wherein the system is adapted to disable the window component if the cursor is stationary for a given period of time and text is detected beneath the cursor.

19. An Internet advertising and information delivery system comprising:
a targeted localized advertising and information delivery system comprising:
a processor for identifying unique identifier information of a user; and
an advertising and/or other information database for storing advertisements and/or other information and for pushing advertisements and/or other information to the user based upon the unique identifier information identified by the processor.

20. The Internet advertising and information delivery system of claim 19 wherein the advertisements and/or other information from the advertising and/or other information database are pushed to traditional banner advertisements.

21. The Internet advertising and information delivery system of claim 19 wherein the advertisements and/or other information from the advertising and/or other information database are pushed to a window component of a cursor.

22. The Internet advertising and information delivery system of claim 19 wherein said processor identifies the physical location of the Internet access of the user, and said advertising and/or other information database is adapted to push advertising and/or other information to the user based upon the Internet access location identified by the processor.

23. The Internet advertising and information delivery system of claim 22 wherein said processor includes means for identifying a current physical location of the Internet access of the user using at least one from an access conduit of the user including a telephone number, DSL information, lease line information and cable information.

24. The Internet advertising and information delivery system of claim 23 wherein said processor locates basic account information of the user.

25. An Internet advertising and information delivery method comprising:
providing a cursor on a computer screen wherein the cursor has a pointer component and a window component adjacent to the pointer component; and
displaying advertising and/or other information in the window component of the cursor.

26. An Internet advertising method comprising:
identifying a current location identifier associated with a user; and
delivering localized advertising and/or other information to the user based upon the location identifier used by the user

27. The Internet advertising and information delivery method of claim 26 further comprising:
providing a cursor on a computer screen wherein the cursor comprises a pointer component and a window component adjacent to the pointer component; and
displaying the localized advertising and/or other information in the window component of the cursor.

28. An Internet advertising and information delivery method comprising:
identifying a personalized profile associated with a user; and
delivering localized advertising and/or other information to the user based upon the personalized profile associated with the user.
